(19) United States
(12) Patent Application Publication
(10) Pub. No.: US 2009/0002544 A1
(43) Pub. Date: Jan. 1, 2009

(54) METHODS OF ADDING ADDITIONAL PARAMETERS DURING AUTOMATIC EXPOSURE FOR A DIGITAL CAMERA AND RELATED ELECTRONIC DEVICES AND COMPUTER PROGRAM PRODUCTS

(75) Inventor: Sune Montan, Lund (SE)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 11/771,418

(22) Filed: Jun. 29, 2007

(51) Int. Cl. H04N 5/238; G03B 7/00

(52) U.S. Cl. 348/363; 396/213; 348/E05.04

(57) ABSTRACT

An electronic device includes a camera that includes an automatic exposure module. The automatic exposure module is configured to determine an exposure for a picture by automatically adjusting an aperture size, shutter timing, and/or an ISO setting. The automatic exposure module is further configured to automatically adjust at least one parameter in addition to the aperture size, shutter timing and/or ISO setting in determining the exposure for the picture.

### BACKGROUND OF THE INVENTION

The present invention relates to electronic devices, and, more particularly, to electronic devices that include a digital camera and methods and computer program products for operating the same.

Traditional cameras use film to capture and store an image. Digital cameras, however, use an electronic device called an image sensor. An image sensor contains many photosensitive diodes called photosites or pixels. When a camera's shutter opens, light is allowed to fall on the photosites/pixels. The photons from the light are converted into electrons at the photosites/pixels. The more light that is received, the higher the charge that accumulates at the individual photosites/pixels. The charge recorded at each of the photosites/pixels is stored as a set of numbers that can be used to reconstruct the image on a display or printed page, for example. The number of pixels in an image depends on where/how the image is displayed. On an image sensor there is a one-to-one relationship between photosites and pixels. When an image is displayed, however, a camera or other image processor may add or subtract pixels. For example, the optical resolution of a camera generally refers to the absolute number of photosites on the image sensor. To improve resolution, a process called interpolated resolution may be performed in which pixels are added by examining pixels adjacent to a newly added pixel and estimating the color and brightness associated with the new pixel based on the characteristics of the surrounding pixels.

In smaller digital cameras, such as those used in mobile terminals, for example, it may be desirable to use an image sensor with relatively small photosites/pixels so as to conserve space. Unfortunately, the decreased photosite/pixel size may also reduce sensitivity and photosite/pixel well capacity (i.e., amount of charge that can accumulate in each photosite/pixel). This may result in poorer low light performance and potential noise problems, such as shot noise caused by the random arrival of photons.

### SUMMARY OF THE INVENTION

According to some embodiments of the present invention, an electronic device includes a camera that includes an automatic exposure module. The automatic exposure module is configured to determine an exposure for a picture by automatically adjusting an aperture size, shutter timing, and/or an ISO setting. The automatic exposure module is further configured to automatically adjust at least one parameter in addition to the aperture size, shutter timing and/or ISO setting in determining the exposure for the picture.

In other embodiments, the at least one additional parameter is binning.

In still other embodiments, the at least one additional parameter is frame adding.

In still other embodiments, the at least one additional parameter includes binning and frame adding.

In still other embodiments, the electronic device further includes a user interface that is configured to receive a selection from a user of the at least one additional parameter.

In still other embodiments, the user interface is further configured to present binning and frame adding for selection as the at least one additional parameter and to receive the selection from the user of binning and/or frame adding as the at least one additional parameter.

In still other embodiments, the electronic device further includes a user interface that is configured to present environment options to a user and to receive a selection from the user of one of the environment options. The automatic exposure module is further configured to select the at least one additional parameter based on the selected one of the environment options.

In still other embodiments, the electronic device is a mobile terminal.

In further embodiments of the present invention, an electronic device that includes a camera operates by determining an exposure for a picture by automatically adjusting an aperture size, shutter timing, and/or an ISO setting and at least one additional parameter.

In still further embodiments, the at least one additional parameter is binning.

In still further embodiments, the at least one additional parameter is frame adding.

In still further embodiments, the at least one additional parameter includes binning and frame adding.

In still further embodiments, the method further includes receiving a selection from a user of the at least one additional parameter via a user interface.

In still further embodiments, the method further includes presenting binning and frame adding as the at least one additional parameter via the user interface and receiving the selection from the user of binning and/or frame adding as the at least one additional parameter.

In still further embodiments, the method further includes presenting environment options to a user via a user interface, receiving a selection from the user of one of the environment options, and selecting the at least one additional parameter based on the selected one of the environment options.

In still further embodiments, the electronic device is a mobile terminal.

In other embodiments of the present invention, a computer program product for operating an electronic device that includes a camera includes a computer readable storage medium having computer readable program code embodied therein. The computer readable program code includes computer readable program code configured to determine an exposure for a picture by automatically adjusting an aperture size, shutter timing, and/or an ISO setting and at least one additional parameter.

In still other embodiments, the at least one additional parameter includes binning and frame adding.

In still other embodiments, the computer program product further includes computer readable program code configured to receive a selection from a user of the at least one additional parameter via a user interface.

In still other embodiments, the computer program product further includes computer readable program code configured to present environment options to a user via a user interface, computer readable program code configured to receive a selection from the user of one of the environment options, and computer readable program code configured to select the at least one additional parameter based on the selected one of the environment options.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram that illustrates a mobile terminal that includes a camera having an automatic exposure capability in accordance with some embodiments of the present invention;

FIGS. 2A and 2B are block diagrams that illustrate pixel binning;

FIG. 3 is a flow chart that illustrates operations for determining an exposure for a picture by automatically adjusting an aperture size, shutter timing, and/or an ISO setting along with one or more additional parameters in accordance with some embodiments of the present invention; and

FIGS. 4 and 5 illustrate user interfaces for communicating with an automatic exposure module to select parameters for use in determining an exposure for a picture in accordance with some embodiments of the present invention.

### DETAILED DESCRIPTION OF PREFERRED EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as methods, electronic devices, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

As used herein, the term “mobile terminal” may include a satellite or cellular radiotelephone with or without a multi-line display; a Personal Communications System (PCS) terminal that may combine a cellular radiotelephone with data processing, facsimile and data communications capabilities; a PDA that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices.

For purposes of illustration, embodiments of the present invention are described herein in the context of a mobile terminal. It will be understood, however, that the present invention is not limited to such embodiments and may be embodied generally as an electronic device that includes a digital camera.

In some embodiments of the present invention, an electronic device, such as a mobile terminal, can include a digital camera that has an automatic exposure capability. The automatic exposure capability may use such parameters as aperture size, shutter timing, and/or ISO setting, which indicates the sensitivity of the camera's image sensor to light, to determine an exposure for a picture. In addition, the automatic exposure capability may use one or more additional parameters, such as binning and/or frame adding to determine an exposure for the picture. The inclusion of additional parameters during automatic exposure may increase the sensitivity and/or dynamic range of the camera.

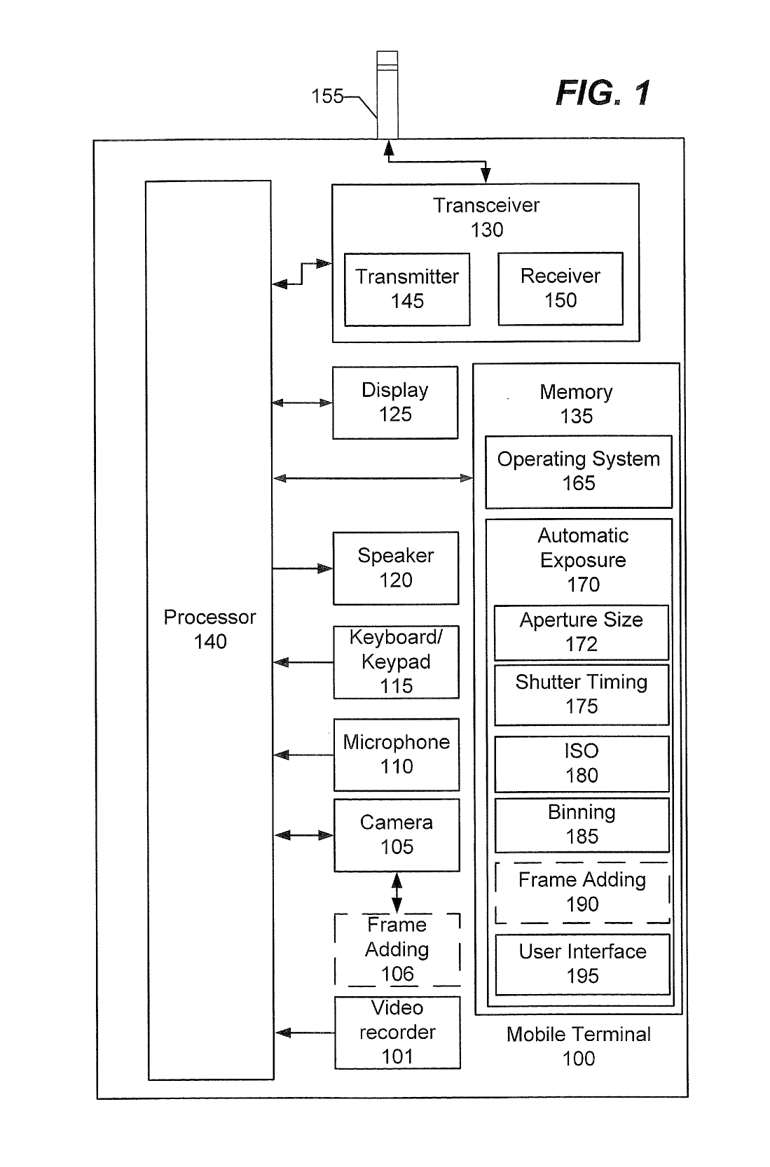

Referring to FIG. 1, an exemplary mobile terminal 100, in accordance with some embodiments of the present invention, comprises a video recorder 101, a camera 105 that may communicate with a frame adding module 106, a microphone 110, a keyboard/keypad 115, a speaker 120, a display 125, a transceiver 130, and a memory 135 that communicate with a processor 140. The transceiver 130 comprises a transmitter circuit 145 and a receiver circuit 150, which respectively transmit outgoing radio frequency signals to base station transceivers and receive incoming radio frequency signals from the base station transceivers via an antenna 155. The radio frequency signals transmitted between the mobile terminal 100 and the base station transceivers may comprise both traffic and control signals (e.g., paging signals/messages for incoming calls), which are used to establish and maintain communication with another party or destination. The radio frequency signals may also comprise packet data information, such as, for example, cellular digital packet data (CDPD) information. The foregoing components of the mobile terminal 100 may be included in many conventional mobile terminals and their functionality is generally known to those skilled in the art.

The processor 140 communicates with the memory 135 via an address/data bus. The processor 140 may be, for example, a commercially available or custom microprocessor. The memory 135 is representative of the one or more memory devices containing the software and data used to operate the mobile terminal 100 as well as provide an automatic exposure capability for the camera 105 in accordance with some embodiments of the present invention. The memory 235 may include, but is not limited to, the following types of devices: cache, ROM, PROM, EPROM, EEPROM, flash, SRAM, and DRAM.

As shown in FIG. 1, the memory 135 may contain up to two or more categories of software and/or data: the operating system 165 and an automatic exposure module 170. In particular, the operating system 165 may manage the mobile terminal's software and/or hardware resources and may coordinate execution of programs by the processor 140. The automatic exposure module 170 may be configured to automatically determine an exposure for a picture taken by the camera 105. As used herein, the term exposure means the quantity of light allowed to act on the camera's image sensor, which is a product of the intensity and the duration of light striking the photosites/pixels of the image sensor.

In some embodiments of the present invention, the automatic exposure module includes an aperture size module 172, a shutter timing module 175, an ISO setting module 180, a frame adding module 190, and/or a user interface module 195. The aperture size module 172 may be configured to automatically adjust the size of the aperture, which is the lens diaphragm opening inside a photographic lens. The size of the aperture is one way to regulate the amount of light that passes through the lens and onto the image sensor. In some types of cameras, however, the aperture size may be fixed and may not be available for adjusting the exposure for a picture. In some cameras, the aperture size may be varied for zoom settings, for example, but still may not be variable for exposure adjustments.

The shutter timing module 175 may be configured to automatically adjust the timing or speed of the shutter. For example, if the camera's image sensor has a relatively high sensitivity to light, i.e., a high ISO value, then the shutter speed may be increased as the image sensor is configured for a relatively low light environment. The shutter speed may also be increased to capture an action scene. Conversely, the shutter speed may be decreased for an image sensor that has a relatively low sensitivity to light, i.e., a low ISO value and/or for capturing a still scene in a low light environment.

The ISO module 180 may be configured to adjust the sensitivity of the camera's image sensor to light. The higher the sensitivity, the less light is needed to make an exposure. Taking a picture at a lower ISO number requires more light than if the picture is taken at a higher number. A lower ISO number generates an image with less visible noise than a higher number, however. The ISO setting, aperture size, and shutter timing are often adjusted in combination to generate a desired exposure for a picture.

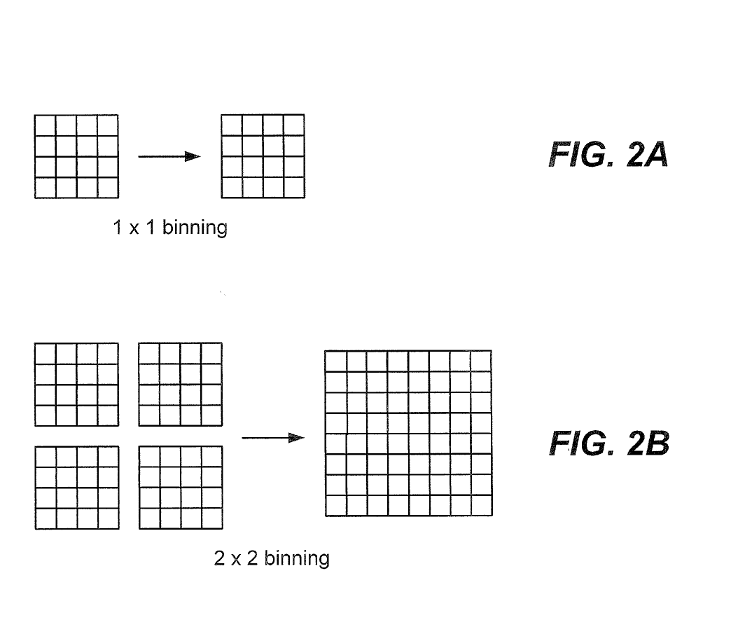

In addition to the three parameters of aperture size, shutter timing, and ISO setting, the automatic exposure module 170 may further include two additional parameters in automatically determining an exposure for a picture: binning and frame adding. The binning module 185 may be configured to perform some ratio of binning on the photosites/pixels in the camera's image sensor. This is illustrated, for example, in FIGS. 2A and 2B. Binning refers to the process of combining the charge of adjacent photosites/pixels into a single larger charge. FIG. 2A illustrates 1×1 binning in which charge from a single photosite/pixel is used as a single pixel to generate the image, i.e., the photosite/pixel from the camera's image sensor is used as is. FIG. 2B, however, illustrates 2×2 binning in which the accumulated charge on four adjacent photosites/pixels is combined into a single “super pixel.” This effectively increases the pixel size while also increasing the sensitivity of the image sensor as more charge is used to represent a single pixel in the resulting picture. While binning provides the advantage of increased sensitivity, a disadvantage is that the resolution of the resulting image is decreased.

Returning to FIG. 1, the frame adding module 190 may be configured to take several picture frames and mathematically combine them to generate a final image. Frame adding may reduce the effects of shot noise in a captured image. Shot noise is caused by the random arrival of photons on the image sensor of the camera 105. While the strength of shot noise increases as the number of photons collected increases, the desired signal strength generally increases more rapidly than the shot noise. It is generally known that the signal-to-noise ratio (SNR) for a digital camera increases in proportion to the square root of the number of photons collected by the image sensor. Cameras that use relatively small photosites/pixels, i.e., photosites/pixels with relatively small well depths, may be more susceptible to shot noise, even in relatively bright light conditions. By combining multiple frames together to construct an image, the amount of photons and charge collected increases, thereby increasing the SNR. For example, if the exposure time for a single frame is 1 ms, then ten frames may be combined for a total exposure time of 10 ms. The SNR may increase in proportion to the square root of ten because of the ten fold increase in charge collected from the image sensor. A 10 ms exposure time may be feasible, particularly for still image environments. Because of the complexity involved in combining multiple frames to form an image, a frame adding hardware module 106 may be used instead of a software module 190 to implement the frame adding functionality, in accordance with some embodiments of the present invention.

The user interface module 195 may allow a user of the mobile terminal 100 to select one or more of the parameters, such as aperture size, shutter timing, ISO setting, binning, and/or frame adding for the automatic exposure module 170 to use in automatically determining an exposure for a picture. In addition to specifying the various parameters directly, the user interface may also identify various environments for a particular scene, allowing the automatic exposure module 170 to adjust the various parameters based on the selected environment.

Although FIG. 1 illustrates an exemplary software and hardware architecture that may be used for automatically determining an exposure for a picture, in accordance with some embodiments of the present invention, it will be understood that the present invention is not limited to such a configuration but is intended to encompass any configuration capable of carrying out the operations described herein. Moreover, the functionality of the hardware/software architecture of FIG. 1 may be implemented as a single processor system, a multi-processor system, or even a network of stand-alone computer systems, in accordance with various embodiments of the present invention.

Computer program code for carrying out operations of devices and/or systems discussed above with respect to FIG. 1 may be written in a high-level programming language, such as Java, C, and/or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

The present invention is described hereinafter with reference to flowchart and/or block diagram illustrations of methods, mobile terminals, electronic devices, data processing systems, and/or computer program products in accordance with some embodiments of the invention.

These flowchart and/or block diagrams further illustrate exemplary operations of automatically determining an exposure for a picture, in accordance with some embodiments of the present invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

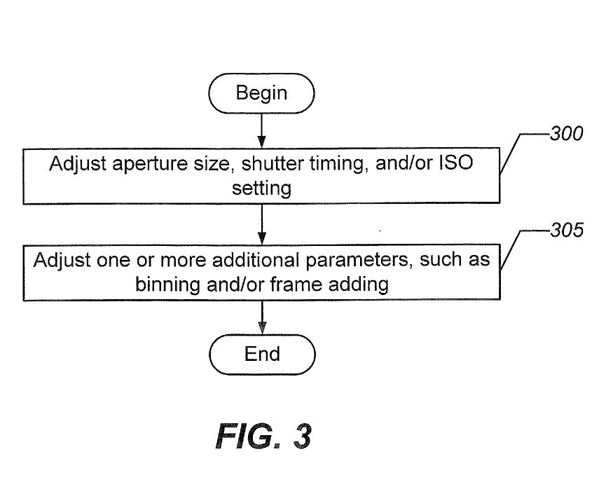

Referring to FIGS. 3 and 1, operations for automatically determining an exposure for a picture begin at block 300 where the automatic exposure module 170 adjusts the aperture size, shutter timing, and/or the ISO setting for the picture. At block 305, the automatic exposure module 170 may include one or more additional parameters in determining the exposure for the picture. The additional parameters may include, but are not limited to, binning and/or frame adding. It will be understood that although the blocks shown in FIG. 3 illustrate various exposure parameters being set sequentially, the operations shown in the blocks may be performed in any order or may be performed in parallel. For example, the various parameters for determining the exposure may be set as a group based on a determined light level and scene selection, for example.

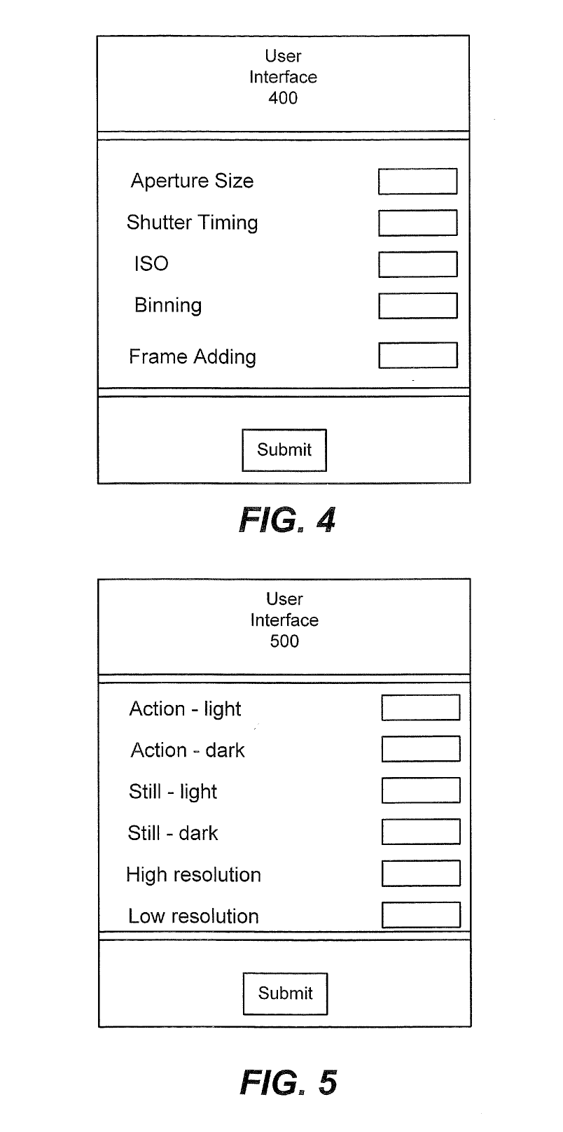

The particular parameters to be included in determining the exposure for the picture may be selected and adjusted automatically by the automatic exposure module 170, in accordance with some embodiments of the present invention. In other embodiments, the automatic exposure module 170 may use the user interface module 195 to obtain input from a user of the camera with regard to which exposure parameters should be used and/or emphasized. For example, FIG. 4 illustrates a user interface 400 in which a user is presented with various exposure parameters, such as aperture size, shutter timing, ISO setting, binning, and frame adding and is allowed to make a selection of which parameters the automatic exposure module 170 should use in determining the exposure for a picture. Because some parameters are related to each other, the automatic exposure module 170 may be configured to emphasize the parameter(s) chosen by the user and adjust other parameters accordingly in an attempt to comply with the user's selection.

FIG. 5 illustrates a user interface 500 in which a user is presented with various environmental settings for the picture. These environmental settings may include, but are not limited to, action scenes in light or dark environments, still scenes in light or dark environments, and high and low resolution preferences. Based on the selected environment and resolution preference, the automatic exposure module 170 may adjust the various parameters such as aperture size, shutter timing, ISO setting, binning, and frame adding to enhance the exposure for that type of scene.

Advantageously, some embodiments of the present invention may allow devices, such as mobile terminals, that include a camera to use additional parameters, such as binning and/or frame adding to determine an exposure for a picture. Because space is often limited in small devices, image sensors used in cameras in such devices often have relatively small pixels. The inclusion of additional parameters during automatic exposure may increase the sensitivity and/or dynamic range of the camera, even if the camera uses relative small size pixels. It will be understood that although binning and frame adding are described herein as additional parameters that may be used in automatically determining an exposure for a picture, other parameters may be used in addition to or in place of one or both of these parameters, in accordance with various embodiments of the present invention.

The flowchart of FIG. 3 illustrates the architecture, functionality, and operations of embodiments of methods, electronic devices, and/or computer program products for automatically determining an exposure for a picture. In this regard, each block represents a module, segment, or portion of code, which comprises one or more executable instructions for implementing the specified logical function(s). It should also be noted that in other implementations, the function(s) noted in the blocks may occur out of the order noted in FIG. 3. For example, two blocks shown in succession may, in fact, be executed substantially concurrently or the blocks may sometimes be executed in the reverse order, depending on the functionality involved.

Many variations and modifications can be made to the preferred embodiments without substantially departing from the principles of the present invention. All such variations and modifications are intended to be included herein within the scope of the present invention, as set forth in the following claims.

That which is claimed:

1. An electronic device, comprising:
a camera that comprises an automatic exposure module, the automatic exposure module being configured to determine an exposure for a picture by automatically adjusting an aperture size, shutter timing, and/or an ISO setting and being further configured to automatically adjust at least one additional parameter.

2. The electronic device of claim 1, wherein the at least one additional parameter is binning in which charge is combined from adjacent photosites.

3. The electronic device of claim 1, wherein the at least one additional parameter is frame adding in which charge from multiple exposures is combined.

4. The electronic device of claim 1, wherein the at least one additional parameter comprises binning in which charge is combined from adjacent photosites and frame adding in which charge from multiple exposures is combined.

5. The electronic device of claim 1, further comprising:
a user interface that is configured to receive a selection from a user of the at least one additional parameter.

6. The electronic device of claim 5, wherein the user interface is further configured to present binning in which charge is combined from adjacent photosites and frame adding in which charge from multiple exposures is combined for selection as the at least one additional parameter and to receive the selection from the user of binning and/or frame adding as the at least one additional parameter.

7. The electronic device of claim 1, further comprising:
a user interface that is configured to present environment options to a user and to receive a selection from the user of one of the environment options; and
wherein the automatic exposure module is further configured to select the at least one additional parameter based on the selected one of the environment options.

8. The electronic device of claim 1, wherein the electronic device is a mobile terminal.

9. A method of operating an electronic device that includes a camera, comprising:
determining an exposure for a picture by automatically adjusting an aperture size, shutter timing, and/or an ISO setting and at least one additional parameter.

10. The method of claim 9, wherein the at least one additional parameter is binning in which charge is combined from adjacent photosites.

11. The method of claim 9, wherein the at least one additional parameter is frame adding in which charge from multiple exposures is combined.

12. The method of claim 9, wherein the at least one additional parameter comprises binning in which charge is combined from adjacent photosites and frame adding in which charge from multiple exposures is combined.

13. The method of claim 9, further comprising:
receiving a selection from a user of the at least one additional parameter via a user interface.

14. The method of claim 13, further comprising:
presenting binning in which charge is combined from adjacent photosites and frame adding in which charge from multiple exposures is combined as the at least one additional parameter via the user interface; and
receiving the selection from the user of binning and/or frame adding as the at least one additional parameter.

15. The method of claim 9, further comprising:
presenting environment options to a user via a user interface;
receiving a selection from the user of one of the environment options; and
selecting the at least one additional parameter based on the selected one of the environment options.

16. The method of claim 1, wherein the electronic device is a mobile terminal.

17. A computer program product for operating an electronic device that includes a camera, comprising:
a computer readable storage medium having computer readable program code embodied therein, the computer readable program code comprising:
computer readable program code configured to determine an exposure for a picture by automatically adjusting an aperture size, shutter timing, and/or an ISO setting and at least one additional parameter.

18. The computer program product of claim 17, wherein the at least one additional parameter comprises binning in which charge is combined from adjacent photosites and/or frame adding in which charge from multiple exposures.

19. The computer program product of claim 17, further comprising:
computer readable program code configured to receive a selection from a user of the at least one additional parameter via a user interface.

20. The computer program product of claim 17, further comprising:
computer readable program code configured to present environment options to a user via a user interface;
computer readable program code configured to receive a selection from the user of one of the environment options; and
computer readable program code configured to select the at least one additional parameter based on the selected one of the environment options.
